(19) United States
(12) Patent Application Publication
(10) Pub. No.: US 2016/0065423 A1
(43) Pub. Date: Mar. 3, 2016

(54) Collecting and Analyzing Selected Network Traffic

(71) Applicant: Microsoft Corporation, Redmond, WA (US)

(72) Inventors: Ming Zhang, Redmond, WA (US); Guohan Lu, Redmond, WA (US); Lihua Yuan, Redmond, WA (US)

(21) Appl. No.: 14/475,927

(22) Filed: Sep. 3, 2014

(51) Int. Cl. H04L 12/26; H04L 12/803

(52) U.S. Cl. CPC H04L 43/02; H04L 43/10; H04L 47/125

(57) ABSTRACT

A tracking system is described herein for investigating the behavior of a network. In operation, each switch in the network (or each switch in some subset of switches) may determine whether each original packet that it processes satisfies one or more packet-detection rules. If so, the switch generates a mirrored packet and sends that packet to a load balancer multiplexer, which, in turn, forwards the mirrored packet to a processing module for further analysis. The packet-detection rules hosted by the switches can be designed to select a subset of packets that are of greatest interest, based on any environment-specific objectives. As a result of this behavior, the tracking system can effectively and quickly pinpoint undesirable (and potentially desirable) behavior of the network, without being overwhelmed with too much information.

### BACKGROUND

It is often difficult to determine the cause of failures and other anomalous events that occur within a network. This difficulty ensues from the complexity of modern networks, coupled with the vast amounts of information that such networks process at any given time. An experienced analyst may address this problem by investigating the behavior of those components of the network that are hypothesized to be most likely at fault, e.g., by examining control information logged by those components. However, the analyst cannot be assured that the information that is inspected will reveal the source of the problem. An analyst may widen the scope of analysis to address this concern, but such a tactic may result in overwhelming the analyst with too much information.

### SUMMARY

A tracking system is described herein for investigating the behavior of a network. In operation, each switch in the network (or each of at least some switches in the network) may determine whether each original packet that it processes satisfies one or more packet-detection rules. If so, the switch may generate a mirrored packet. The mirrored packet includes at least a subset of information in the original packet. The switch may then forward the mirrored packet to a load balancing multiplexer. The switch also sends the original packet in unaltered form to the target destination specified by the original packet.

Upon receipt of the mirrored packet, the multiplexer can select a processing module from a set of candidate processing modules, based on at least one load balancing consideration. The multiplexer then sends the mirrored packet to the selected processing module, where it is analyzed using one or more processing engines.

The packet-detection rules hosted by the switches can be designed to select a subset of packets that are considered of high interest value, in view of any application-specific objective(s). As a result of this behavior, the tracking system can effectively and quickly pinpoint undesirable (and potentially desirable) behavior of the network, without overwhelming an analyst with too much information.

The above approach can be manifested in various types of systems, devices, components, methods, computer readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of one example of a tracking system. The tracking system extracts selected information from a network for analysis.

FIG. 2 shows one non-limiting implementation of the tracking system of FIG. 1.

FIG. 3 shows one implementation of a switch in a network which is configured to perform a mirroring function. That configured switch is one component of mirroring functionality used by the tracking system of FIG. 1.

FIG. 4 shows one implementation of a multiplexer, corresponding to another component of the tracking system of FIG. 1.

FIG. 5 shows multiplexing behavior of the switch of FIG. 3.

FIG. 6 shows multiplexing behavior of the multiplexer of FIG. 4.

FIG. 7 shows an illustrative table data structure that the multiplexer of FIG. 4 can leverage to perform its multiplexing function, according to one implementation.

FIG. 8 shows an example of information that is output by the switch of FIG. 3.

FIG. 9 shows an example of information that is output by the multiplexer of FIG. 4.

FIG. 10 shows one implementation of a processing module, which is another component of the tracking system of FIG. 1.

FIG. 11 shows one implementation of a consuming entity, which is a component which interacts with the tracking system of FIG. 1.

FIG. 12 shows one implementation of a management module, which is another component of the tracking system of FIG. 1.

FIG. 13 shows a process that explains one manner of operation of the switch of FIG. 3.

FIG. 14 shows a process that explains one manner of operation of a matching module, which is a component of the switch of FIG. 3.

FIG. 15 shows a process that explains one manner of operation of the multiplexer of FIG. 4.

FIG. 16 shows a process that explains one manner of operation of the processing module of FIG. 10.

FIG. 17 shows a process that explains one manner of operation of the consuming entity of FIG. 11.

FIG. 18 shows a process that explains one manner of operation of the management module of FIG. 12.

FIG. 19 shows illustrative computing functionality that can be used to implement any aspect of the features shown in the foregoing drawings.

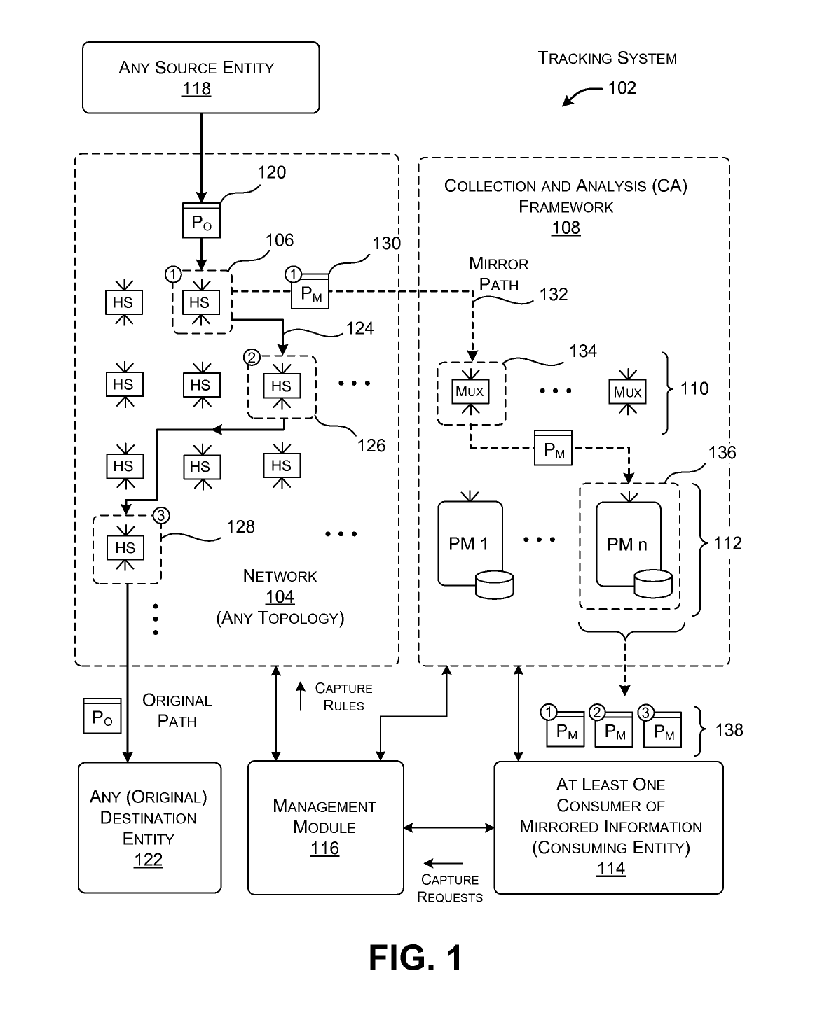

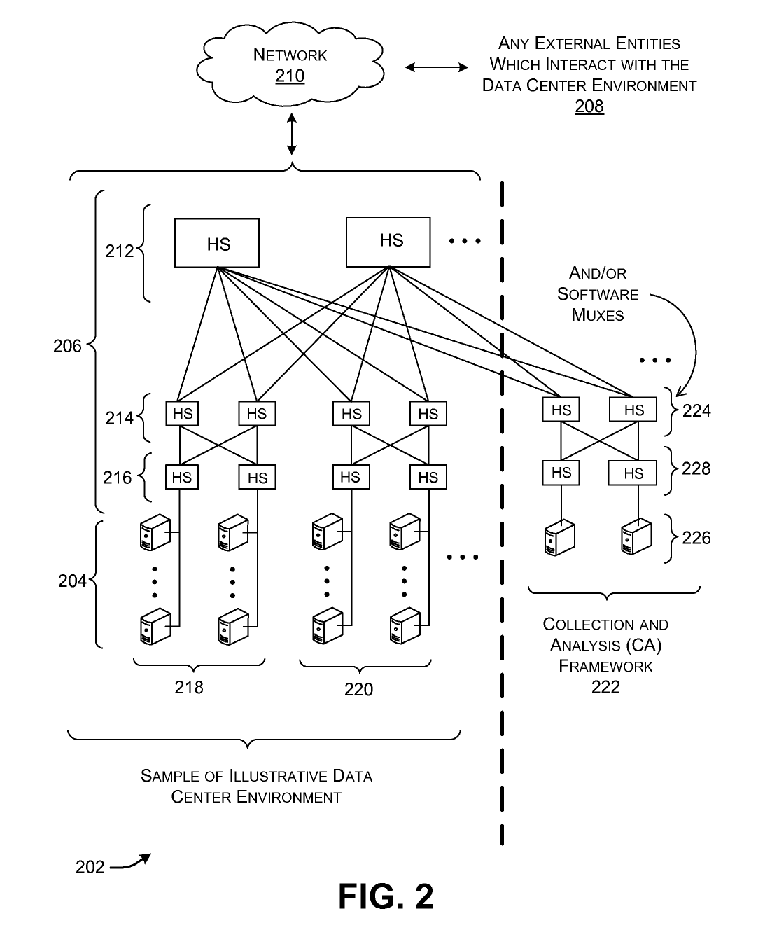

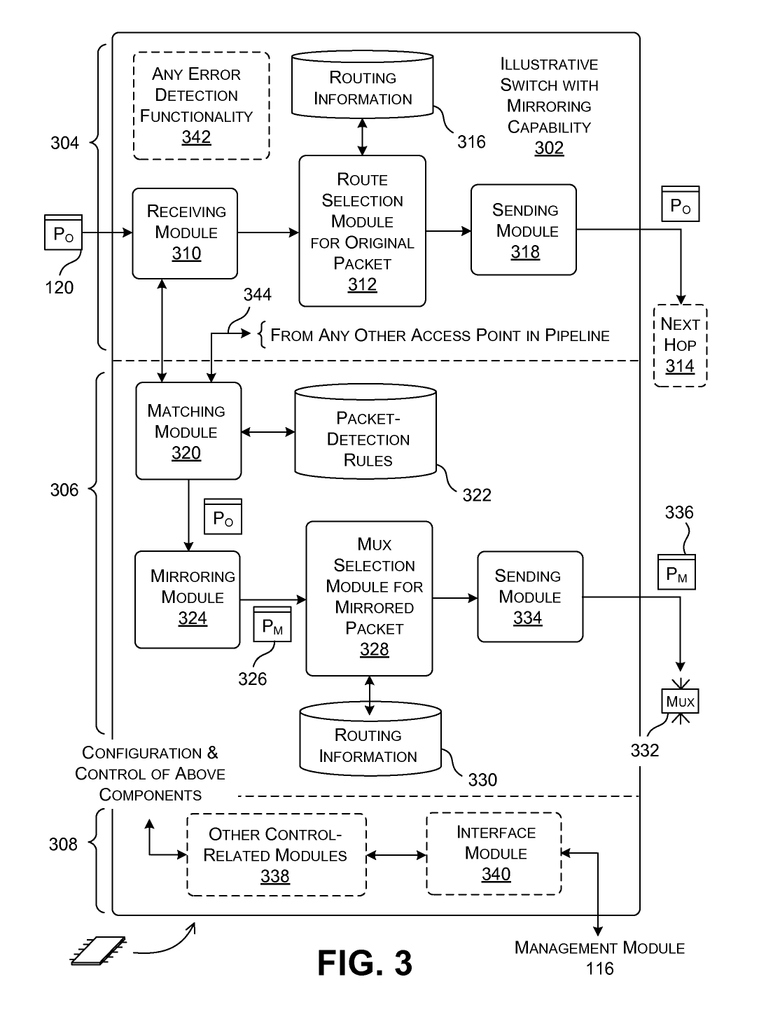

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative tracking system for selectively collecting and analyzing network traffic, e.g., by selectively extracted certain types of packets that are flowing through a network. Section B sets forth illustrative methods which explain the operation of the tracking system of Section A. Section C describes illustrative computing functionality that can be used to implement any aspect of the features described in Sections A and B.

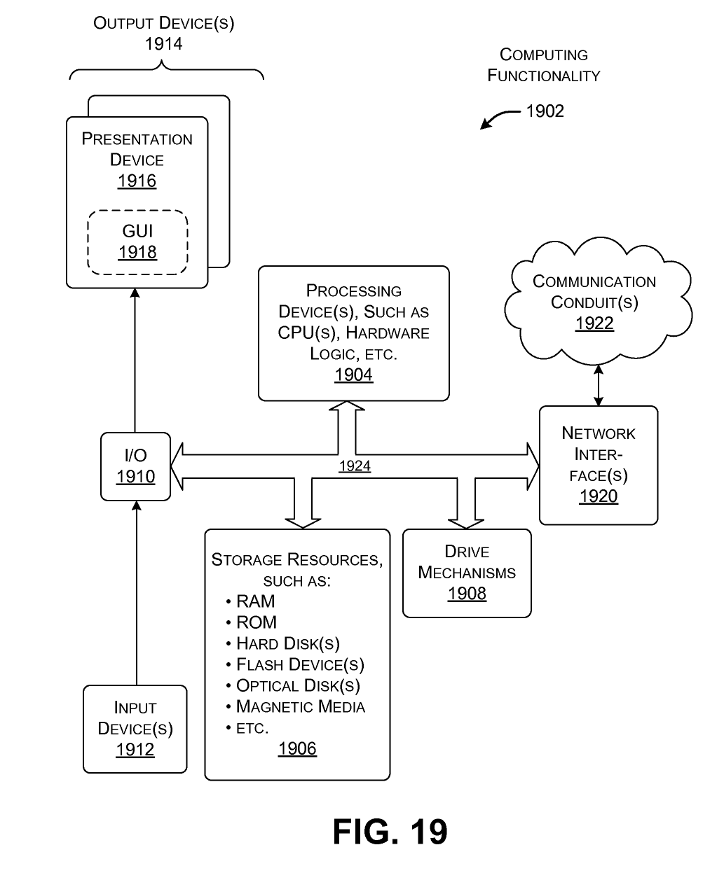

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software running on computer equipment, hardware (e.g., chip-implemented logic functionality), etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 19, to be described in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software running on computer equipment, hardware (e.g., chip-implemented logic functionality), etc., and/or any combination thereof.

As to terminology, the phrase “configured to” encompasses any way that any kind of physical and tangible functionality can be constructed to perform an identified operation. The functionality can be configured to perform an operation using, for instance, software running on computer equipment, hardware (e.g., chip-implemented logic functionality), etc., and/or any combination thereof.

The term “logic” encompasses any physical and tangible functionality for performing a task. For instance, each operation illustrated in the flowcharts corresponds to a logic component for performing that operation. An operation can be performed using, for instance, software running on computer equipment, hardware (e.g., chip-implemented logic functionality), etc., and/or any combination thereof. When implemented by computing equipment, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative Tracking System

A.1. Overview

FIG. 1 shows an overview of one example of a tracking system 102. The tracking system 102 extracts information regarding selected packets that are transmitted over a network 104, and then analyzes those packets. In one use scenario, an analyst may use the information provided by the tracking system 102 to investigate anomalous or undesirable events. In other cases, an analyst may use the information provided the tracking system 102 to investigate desirable behavior in the network 104. Overall, the information provided by the tracking system 102 may provide insight regarding the causes of whatever events are being studied.

Among other potential benefits, the selectivity at which the tracking system 102 culls information from the network 104 reduces the amount of “noise” that is presented to the human analyst or other consumer, and thereby facilitates his or her investigation. It also contributes to the scalability and overall efficiency of the tracking system. Other aspects of the tracking system 102, described below, further contribute to the scalability and efficiency of the packet-collection functionality provided by the tracking system 102.

The network 104 is composed of a plurality of hardware switches, such as representative switch 106. For example, each switch may be implemented by logic functionality provided by an Application Specific Integrated Circuit (ASIC), etc. Although not shown, the network 104 may, in addition, or alternatively, include one or more software-implemented switches. Each switch, in whatever manner it is constructed, performs the primary function of routing an input packet, received from a source, to a destination, based on one or more routing considerations. The source may correspond to another “upstream” switch along a multi-hop path, or the ultimate starting point of the packet. Similarly, the destination may correspond to another switch along the path, or the final destination of the packet.

The network 104 is depicted in only high-level form in FIG. 1. In practice, the network 104 can have any topology. The topology determines the selection of switches in the network 104 and the arrangement (and interconnection) of those switches. Further, the network 104 can be used in any environment. In one case, for example, the network 104 may be used to route packets within a data center, and to route packets between external entities and the data center. In another case, the network 104 may be used in an enterprise environment. In another case, the network 104 may operate in an intermediary context, e.g., by routing information among two or more environments (e.g., between two or more data centers, etc.). Still other applications are possible.

The tracking system 102 has two principal components; mirroring functionality, and a collection and analysis (CA) framework 108. The mirroring functionality collectively represents mirroring mechanisms provided by all of the respective switches in the network 104. In other implementations, a subset of the switches, but not all of the switches, include the mirroring mechanisms. Each mirroring mechanism generates a mirrored packet when its hosting switch receives an original packet that matches one or more packet-detection rules. The mirrored packet contains a subset of information extracted from the original packet, such as the original packet's header information. The mirrored packet also contains a new header which specifies a new destination address (compared to the original destination address of the original packet). The switch then passes the mirrored packet to the CA framework 108, in accordance with the address that it has been assigned by the mirroring mechanism. The CA framework 108 then processes the mirrored packet in various implementation-specific ways.

More specifically, the switch may send the mirrored packet to a multiplexer, selected from among a set of one or multiplexers 110. The chosen multiplexer may then send the mirrored packed to one of a set of processing modules (PMs) 112, based on at least one load balancing consideration. The chosen processing module can then use one or more processing engines to process the mirrored packet (along with other, previously received, mirrored packets).

At least one consuming entity 114 may interact with the processing modules 112 to obtain the mirrored packets. The consuming entity 114 may then perform any application-specific analysis on the mirrored packets, using one or more processing engines. In one case, the consuming entity 114 may correspond to an analysis program that operates in an automatic manner, running on a computing device. In another case, the consuming entity 114 may correspond to an analysis program running on a computing device, under the direction of a human analyst. In some scenarios, the consuming entity 114 is also affiliated with a particular application. In view of this association, the consuming entity may be particularly interested in events in the network which affect its own application.

A management module 116 may control any aspect of the tracking system 102. For example, the management module 116 can instruct the switches in the network 104 to load particular packet-detection rules, for use in capturing particular types of packets that are flowing through the network 104. The management module 116 can also interact with any consuming entity. For example, the consuming entity 114 may identify a problem in the network, and, in response, request the management module 116 to propagate packet-detection rules to the switches; the mirrored packets produced as a result of these rules will help the consuming entity 114 to identify the cause of the problem.

To clarify the above explanation, FIG. 1 depicts the flow of one original packet through the network 104, together with its mirrored counterpart. Later subsections (below) provide additional illustrative details regarding each of the operations introduced in describing the representative flow of FIG. 1.

As shown, any source entity 118 sends an original packet (P_{O}) 120 into the network 104, with the ultimate intent of sending it to any destination entity 122. For example, without limitation, the source entity 118 may correspond to a first computing device and the destination entity 122 may correspond to a second computing device. More specifically, for instance, the destination entity 122 may correspond to a server computing device located in a data center, which hosts a particular application. The source entity 118 may correspond to any computing device which wishes to interact with the application for any purpose.

A packet, as the term is used herein, refers to any unit of information. In one particular implementation, the original packet 120 corresponds to an Internet Protocol (IP) packet having a header and a payload, as specified by the IP protocol. More specifically, the original packet may provide a virtual IP (VIP) address which identifies the destination entity. The destination entity 122, in turn, may be associated with a direct IP (DIP) address. Among other functions, at least on component in the network 104 maps the VIP address to the appropriate DIP address of the destination entity 122.

The network 104 may use any routing protocol to route the original packet 120 through its switching fabric, from the source entity 118 to the destination entity 122. One such protocol that may play a role in establishing routes is the Border Gateway Protocol (BGP), as defined in RFC 4271. Further note that different components in the network 104 that operate on the original packet 120 may append (or remove) various encapsulating headers to (or from) the original packet 120 as it traverses its route.

More specifically, FIG. 1 depicts a merely illustrative case in which the original packet 120 traverses a path 124 that has multiple segments or hops. In a first segment, the original packet 120 is routed to the switch 106. In a second segment, the original packet 120 is routed to another switch 126. In a third segment, the original packet 120 is routed to another switch 128. In a fourth segment, the original packet 120 is routed to the destination entity 122. In actual practice, the path 124 can have any number of hops (including a single hop), and may traverse any switches in the switching fabric defined by the switches. Further, as mentioned above, the network 104 can use one or more tunneling protocols to encapsulate the original packet in other, enclosing packets; such provisions are environment-specific in nature and are omitted form FIG. 1 to facilitate explanation.

The mirroring mechanism on each switch (or on each of a subset of the switches) analyzes the original packet to first determine whether it meets one or more packet-detection rules. If so, the mirroring mechanism will generate a mirrored packet counterpart to the original packet, while leaving the original packet itself intact, and without disturbing the routing of the original packet along the path 124.

For example, consider the operation of switch 106. (Other switches will exhibit the same behavior when they process the original packet 120.) Assume that the switch 106 first determines that the original packet 120 matches at least one packet-detection rule. It then generates a mirrored packet 130. The switch 106 may then forward the mirrored packet 130 along a path 132 to a specified destination (corresponding to one of the multiplexers 110). More specifically, different propagating entities along the path 132 may append (or remove) encapsulating headers to the mirrored packet 130. But, for ease of illustration and explanation, FIG. 1 refers to the mirrored information as simply the mirrored packet 130.

More specifically, in one implementation, the switch 106 can apply at least one load-bearing consideration to select a multiplexer among the set of multiplexers 110. For example, assume that the switch 106 selects the multiplexer 134. In other implementations, the CA framework 108 may provide a single multiplexer; in that case, the switch 106 sends the mirrored packet 130 to that multiplexer without choosing among plural available multiplexers.

The multiplexer 134 performs the function of further routing the mirrored packet 130 to one of the processing modules 112, based on at least one load-bearing consideration. The multiplexer 134 will also choose a target processing module such that mirrored packets that pertain to the flow through the network 104 are sent to the same processing module. The multiplexer 134 itself can be implemented in any manner. In one case, the multiplexer 134 may correspond to a hardware-implemented multiplexer, such as logic functionality provided by an Application Specific Integrated Circuit (ASIC). In another case, the multiplexer 134 corresponds to a software-implemented multiplexer, such as a multiplexing program running on a server computing device. In other cases, the collection of multiplexers 110 may include a combination of hardware multiplexers and software multiplexers.

Assume that the multiplexer 134 routes the mirrored packet 130 to a particular processing module 136. In one implementation, the processing module 136 may correspond to a server computing device. Upon receipt, the processing module 136 can perform various operations on the mirrored packet 130. In one such function, the processing module 136 can associate the mirrored packet with other packets that pertain to the same path 124 (if any), and then sort the mirrored packets in the order that they were created by the switches. For example, at the completion of the original packet's traversal of its path 124, the processing module 136 can generate the packet sequence 138, corresponding to the sequence of mirrored packets created by the switches 106, 126, and 128.

The consuming entity 114 may extract any packet-related information stored by the processing module 136, and then analyze that information in any manner. The following description provides examples of analysis that may be performed by a consuming entity 114. FIG. 1 specifically shows that the consuming entity 114 extracts or otherwise accesses at least the sequence 138 associated with the path 124 of the original packet 120 through the network 104. In other cases, the consuming entity 114 can request and receive specific mirrored packets, rather than sequences of packets.

A.2. Example of a Particular Network Environment

FIG. 2 shows an environment 202 which includes one non-limiting implementation of the tracking system 102 of FIG. 1. The environment 202 corresponds to a data center that includes a plurality of computing devices 204, such as a plurality of servers. A network 206 allows computing devices 204 within the data center to communicate with other computing devices within the data center. The network 206 also allows external entities 208 to interact with the computing devices 204. A wide area network 210, such as the Internet, may couple the data center's network 206 with the entities 208.

The network 206 can have any topology. As shown in the particular and non-limiting example of FIG. 2, the network 206 includes a plurality of switches in a fat-tree hierarchical topology. Without limitation, the switches can include core switches 212, aggregation switches 214, top-of-rack (TOR) switches 216, and so on. Further, the network 206 may organize the computing device 204 into containers, such as containers 218 and 220. An actual data center may include many more switches and computing units; FIG. 2 shows only a representative and simplified sample of the data center environment's functionality.

All of the switches in the network 206, or some subset thereof, include mirroring mechanisms. The mirroring mechanisms generate mirrored packets when they process original packets (assuming that the original packets satisfy one or more packet-detection rules). The mirroring mechanisms then forward the mirrored packets to a collection and analysis (CA) framework 222.

More specifically, the CA framework 222 may provide dedicated equipment for handling the collection and analysis of mirrored packets. In other words, the CA framework 222 may not perform any role in the routing of original packets through the network 206. (But in other implementations, the CA framework 222 may perform a dual role of routing original packets and processing mirrored packets.) In one case, the CA framework 222 includes one or more multiplexers 224. The multiplexers may correspond to hardware multiplexers, and, more specifically, may correspond to hardware switches that have been reconfigured to perform a multiplexing role. Alternatively, or in addition, at least a subset of the multiplexers 224 may correspond to software-implemented multiplexers (e.g., corresponding to one or more server computing devices).

The multiplexers 224 may be coupled to the top-level switches 212 of the network 206, and/or to other switches. Further, the multiplexers 224 may be directly coupled to one or more processing modules 226. Alternatively, as shown in FIG. 2, the multiplexers 224 may be connected to the processing modules via switches 228, using any connection topology.

A.3. Illustrative Switch having Mirroring Capability

FIG. 3 shows an illustrative switch 302 that has mirroring capability, meaning that it has the ability to generate and forward packets that are mirrored counterparts of original packets. As noted above, the switch 302 can be implemented as a hardware unit (e.g., as an ASIC).

From a high-level perspective, the switch 302 may include functionality for performing three main functions. Functionality 304 allows the switch 302 to perform its traditional role of forwarding a received original packet to a target destination. Functionality 306 performs the mirroring aspects of the switch's operation. And functionality 308 performs various management functions. More specifically, for ease of explanation, FIG. 3 illustrates these three functionalities (304, 306, 308) as three separate domains. However, in some implementations, a single physical module may perform two or more functions attributed to the distinct domains shown in FIG. 3.

Beginning with the functionality 304, a receiving module 310 receives the original packet 120 from any source. The source may correspond to the source entity 118 of FIG. 1, or another “upstream” switch. A route selection module 312 chooses the next destination of the original packet, corresponding to a next hop 314. The next hop 314, in turn, may correspond to the ultimate target destination of the original packet, or another “downstream” switch along a multi-hop path. The route selection module 312 may consult routing information provided in a data store 316 in choosing the next hop 314. The route selection module 312 may also use any protocol in choosing the next hop 314, such as BGP. A sending module 318 sends the original packet to the next hop 314. Although not explicitly shown in FIG. 3, the sending module 318 may optionally use any encapsulation protocol to encapsulate the original packet in another packet, prior to sending it to the next hop 314.

With respect to the mirroring functionality 306, a matching module 320 determines whether the original packet 120 that has been received matches any of the packet-detection rules which are stored in a data store 322. Illustrative rules will be set forth below. A mirroring module 324 generates a mirrored packet 326 if the original packet 120 satisfies any one or more of the packet-detection rules. As described above, the mirroring module 324 can produce the mirrored packet 326 by extracting a subset of information from the original packet 120, such as the original packet's header. The mirroring module 324 can also add information that is not present in the original packet 120, such as metadata produced by the switch 302 itself in the course of processing the original packet 120. In some implementations, the mirroring module 324 can use available packet-copying technology to create the mirrored packet 326, such as the Encapsulated Remote Switched Port Analyzer (ERSPAN) technology provided by Cisco Systems, Inc., of San Jose, Calif.

A mux selection module 328 chooses a multiplexer, among a set of multiplexers 110 (of FIG. 1), to which to send the mirrored packet 326. In the context of FIG. 3, assume that the mux selection module 328 selects a multiplexer 332. For example, the mux selection module 328 can use a hashing algorithm to hash any tuple of information items conveyed by the mirrored packet, such as different information items provided in the header of the original packet's IP header (which is information copied into the mirrored packet). The hashing operation produces a hash result, which, in turn, may be mapped to a particular multiplexer. All switches that have mirroring mechanisms employ the same hash function. Overall, the hashing operation has the effect of spreading mirrored packets over the available set of multiplexers 110. A data store 330 may provide information to which the mux selection module 328 may refer in performing its operation; for example, the data store 330 may identify the available multiplexers 110, e.g., by providing their respective addresses.

A sending module 334 sends the mirrored packet to the multiplexer 332. In one case, the sending module 334 can use any tunneling protocol (such as Generic Routing Encapsulation (GRE)), to encapsulate the mirrored packet in a tunneling packet, and then append a multiplexing IP header “on top” of the tunneling protocol header. GRE is described, for example, in RFC 2784. The sending module 318 produces an encapsulated mirrored packet 336.

As to the management functionality 308, the switch 302 may include other control modules 338 for handling other respective tasks. For example, a routing management module may perform tasks such as broadcasting the existence of the switch 302 to other switches in the network, determining the existence of other switches, updating the routing information in the data stores (316, 330) and so on. An interface module 340 may receive management information and other instructions from the management module 116.

Now referring to the matching module 320 in greater detail, that component can compare the original packet 120 with different types of packet-detection rules. The following explanation provides representative examples of packet-detection rules. Such a list is provided in the spirit of illustration, rather than limitation; other implementation can rely on addition types of packet-detection rules not mentioned below.

A first kind of packet-detection rule may specify that the original packet 120 is to be mirrored if it expresses a protocol-related characteristic, such as by containing a specified protocol-related information item or items(s), e.g., in the header and/or body of the original packet 120. That information, for instance, may correspond to a flag produced by a transport level error-checking protocol, such as the Transmission Control Protocol (TCP). In another case, the triggering condition may correspond to one or more information items produced by a routing protocol, such as BGP.

A second kind of packet-detection rule may specify that the original packet 120 is to be mirrored if it expresses that it originated from a particular application, e.g., by containing an application-related information item or items. The application-related information item(s) may correspond to a flag, code, address, etc. The application may add the information item(s) to the packets that it produces in the course of its normal execution.

A third kind of packet-detection rule corresponds to a user-created packet-detection rule. That kind of rule specifies that the original packet is to be mirrored if it satisfies a user-specified matching condition. The user may correspond to a network administrator, a test engineer, an application or system developer, an end user of the network 104, etc. For example, a user may create a rule that specifies that any packet that contains identified header information is to be mirrored.

A fourth kind of packet-detection rule may specify that the original packet 120 is to be mirrored if it expresses that a particular condition or circumstance was encountered when the switch 302 processed the original packet 120. For instance, the rule may be triggered upon detecting an information item in the original packet that was been added by the switch 302; that information item indicates that the switch 302 encountered an error condition or other event when processing the original packet 120.

More specifically, for example, the functionality 304 used by the switch 302 to forward the original packet 120 may be implemented as a processing pipeline, where a series of operations are performed on the original packet 120 in series. At one or more stages, error detection functionality 342 may detect an error condition in its processing of the original packet 120. For example, during the receiving or route selection phases of analysis, the error detection functionality 342 may determine that the original packet 120 has been corrupted, and therefore cannot be meaningfully interpreted, and therefore cannot be forwarded to the next hop 314. In response, the error detection functionality 342 may append a flag or other information item to the original packet 120, indicating that it will be dropped. A later stage of the processing pipeline of the functionality 304 may then perform the express step of dropping the original packet 120.

Before the drop happens, however, the matching module 320 can detect the existence of the information item that has been added, and, in response, the mirroring module 324 can mirror the original packet 120 with the information added thereto (even though, as said, that packet will eventually be dropped). Such a mirrored packet provides useful information, during analysis, to identify the cause of a packet drop.

The matching module 320 includes an input 344 to generally indicate that the matching module 320 can compare the original packet 120 against the packet-detection rules at any stage in the processing performed by the switch 302, not necessarily just at the receiving stage. As such, in some circumstances, the original packet 120 may not, upon initial receipt, contain a certain field of information that triggers a packet-detection rule; but the switch 302 itself may add the triggering information item at a later stage of its processing, prompting the matching module 320 to later successfully match the amended packet against one of the rules.

As an aside, the tracking system 102 may provide additional techniques for detecting packet drops. For example, a processing module or a consuming entity may detect the existence of a packet drop by analyzing the sequence of mirrored packets produced along the path of the original packet's traversal of the network. A packet drop may manifest itself in a premature truncation of the sequence, as evidenced by the fact that the original packet did not reach its intended final destination. Or the sequence may reveal a “hole” in the sequence that indicates that a hop destination was expected to receive a packet, but it did not (although, in that case, the packet may have ultimately still reached its final destination).

In other circumstances, the switch 302 can add metadata information to the original packet 120 to indicate that some other condition was encountered by the switch 302 when processing the original packet 120, where that condition is not necessarily associated with an error.

A fifth kind of packet-detection rule may specify that the original packet 120 is to be mirrored if it specifies an identified service type that is to be mirrored. For example, that type of packet-detection rule can decide to mirror the original packet 120 based on a Differentiated Service Code Point (DSCP) value that is specified by the original packet 120, etc.

A sixth kind of packet-detection rule may specify that the original packet 120 is to be mirrored if it is produced by a ping-related application. More specifically, the ping-related application operates by sending the original packet to a target entity, upon which the target entity is requested to send a response to the original packet.

To repeat, other environments can apply additional types of packet-detection rules. For instance, other rules may be triggered upon the detection of certain IP source and/or destination addresses, or TCP or UDP source and/or destination ports, and so on. Further, in some cases, a packet-detection rule may be triggered upon the detection of a single information item in the original packet 120, such a single flag in the original packet 120. But in other cases, a packet-detection rule may be triggered upon the detection of a combination of two or more information items in the original packet 120, such as a combination of two flags in the original packet 120. Further, in any of the above cases, the information item(s) may appear in the header and/or body of the original packet 120. Alternatively, or in addition, a packet-detection rule may be triggered by other characteristic(s) of the original packet 120, that is, some characteristic other than the presence or absence of particular information items in the header or body of the original packet 120. For example, a rule may be triggered upon detecting that the original packet 120 is corrupted, or has some other error, or satisfies some other matching condition.

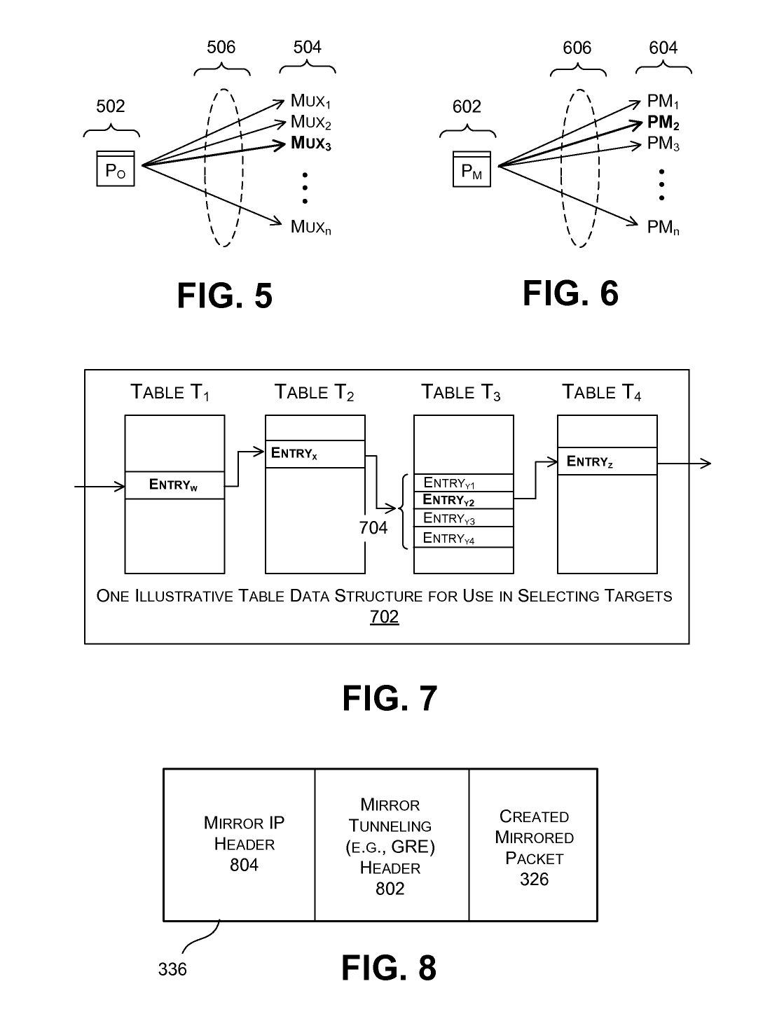

Jumping ahead momentarily in the sequence of figures, FIG. 5 shows the multiplexing function performed by the mux selection module 328 of FIG. 3. As indicated there, the mux selection module 328 maps an original packet 502 to one of a set of multiplexers 504, using some spreading algorithm 506 (such as hashing algorithm which operates on some tuple of the original packet's IP header).

More specifically, in one case, each of the multiplexers may be represented by its own unique VIP address. The mux selection module 328 therefore has the effect of choosing among the different VIP addresses. In another case, the collection of multiplexers may have different direct DIP address, but the same VIP address. Any load balancing protocol (such as Equal-cost multi-path routing (ECMP)) can be used to spread the mirrored packets among the multiplexers. ECMP is defined in RFC 2991.

FIG. 8 shows an illustrative structure of the encapsulated mirrored packet 336 that is generated at the output of the mirroring-capable switch 302. The encapsulated mirrored packet 336 includes the above-specified mirrored packet 326 that is produced by the mirroring module 324, e.g., corresponding to a subset of the information in the original packet 120, e.g., by providing at least the header of the original packet 120. An encapsulating outer field includes a mirror tunneling header 802, such as a GRE tunneling header. A next encapsulating outer field includes a mirror IP header 804. Other implementations may adopt other ways of encapsulating the mirrored packet 326.

A.4. Illustrative Multiplexer

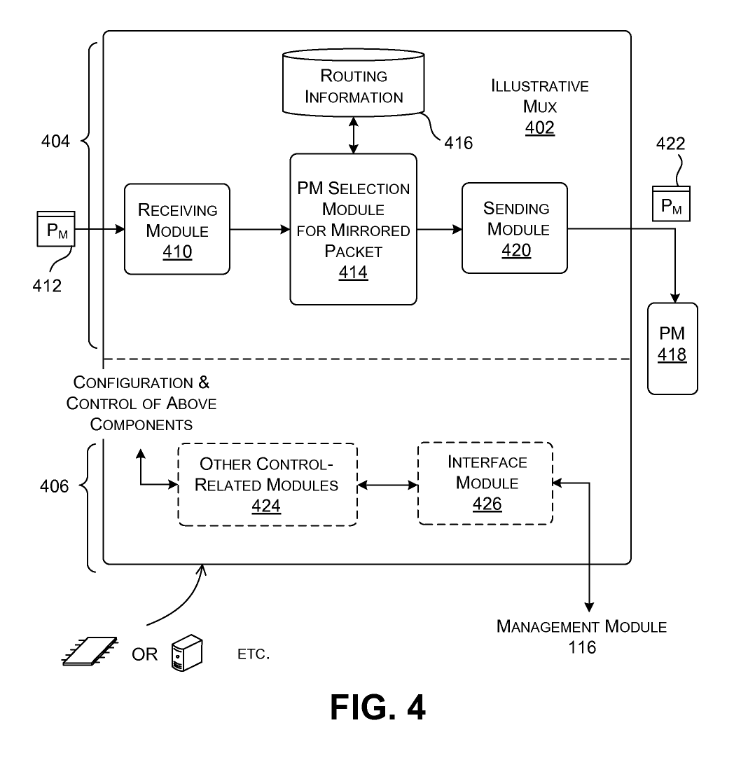

FIG. 4 shows one implementation of a multiplexer 402. The multiplexer 402 may correspond to one of the set of multiplexers 110 shown in FIG. 1. Or the multiplexer 402 may correspond to the sole multiplexer provided by the tracking system 102. The multiplexer 402 may correspond to a hardware-implemented device or a software-implemented device, or some combination thereof. In the former case, the hardware multiplexer may correspond to a commodity switch which has been reprogrammed and repurposed to perform a multiplexing function. Or the hardware multiplexer may correspond to a custom-designed component that is constructed to perform the functions described below.

The multiplexer 402 includes functionality 404 for performing the actual multiplexing function, together with functionality 406 for managing the multiplexing function. For example, the functionality 404 may include a receiving module 410 for receiving a mirrored packet 412. (More precisely, the mirrored packet 412 corresponds to the kind of encapsulated mirrored packet 336 produced at the output of the switch 302, but it referred to as simply a “mirrored packet” 412 for brevity below.) The functionality 404 may also include a PM selection module 414 for selecting a processing module among a set of candidate processing modules 112. The PM selection module 414 consults routing information in a data store 416 in performing its operation. Assume that the PM selection module 414 chooses to send the mirrored packet 412 to the PM 418. A sending module 420 sends the mirrored packet 412 to the PM 418. In doing so, the sending module 420 can encapsulate the mirrored packet 412 in a tunneling protocol header (such as a GRE header), and then encapsulate that information in yet another outer IP header, to produce an encapsulated mirrored packet 422. The control-related modules 424 may manage any aspect of the operation of the multiplexer. For example, the control related modules 424 may provide address information, for storage in the data store 416, which identifies the addresses of the PMs. An interface module 426 interacts with the management module 116 (of FIG. 1), e.g., by receiving control instructions from the management module 116 that are used to configure the operation of the multiplexer 402.

The PM selection module 414 may select a PM from the set of PMs 112 based on any load balancing consideration. In one approach, the PM selection module 414 uses a hashing algorithm to hash information items contained with the header of the original packet, which is information that is also captured in the mirrored packet. The resultant hash maps to one of the processing modules 112. The hashing algorithm also ensures that packets that pertain to the same packet flow are mapped to the same processing module. The tracking system 102 can achieve this result by selecting input information items from the original packet (which serve as an input key to the hashing algorithm) that will remain the same as the original packet traverses the path through the network 104, or which will otherwise produce the same output hash value when acted on by the hashing algorithm. Further, the tracking system 102 deploys the same hashing algorithm on all of the multiplexers 110.

FIG. 6 depicts the multiplexing function performed by the PM selection module 414 of FIG. 4. As indicated there, the PM selection module 414 maps a received mirror packet 602 to one of a set of PMs 604, using some spreading algorithm 606 (such as the above-described hashing algorithm).

In one case, each of the processing modules 112 may be represented by its own unique VIP address. The PM selection module 414 therefore has the effect of choosing among the different VIP addresses. In another case, the collection of processing modules 112 may have different direct address (DIPs), but the same VIP address. Any load balancing protocol (such as ECMP) can be used to spread the mirrored packets among the processing modules 112.

FIG. 7 shows an illustrative table data structure 702 that the PM selection module 414 can use to perform its multiplexing function. The data store 416 may store the table data structure 702. More specifically, FIG. 7 corresponds to an implementation in which the multiplexer 402 is produced by reprogramming and repurposing a hardware switch. In that case, the switch may have a set of tables that can be reprogrammed and repurposed to support a multiplexing function, which is not the native function of these tables.

More specifically, in one implementation, the table data structure 702 includes a set of four linked tables, including table T₁, table T₂, table T₃, and table T₄. FIG. 7 shows a few representative entries in the tables, denoted in a high-level manner. In practice, the entries can take any form. Assume that the multiplexer 402 receives a packet from any source, e.g., corresponding to mirrored packet 412. The packet has a header that specifies a particular address associated with a destination to which the packet is directed. The PM selection module 414 first uses the input address as an index to locate an entry (entry_{w}) in the first table T₁. That entry, in turn, points to another entry (entryₓ) in the second table T₂. That entry, in turn, points to a contiguous block 704 of entries in the third table T₃. The PM selection module 414 chooses one of the entries in the block 704 based on any selection logic. For example, as explained above, the PM selection module 414 may hash one or more information items extracted from the original packet's IP header to produce a hash result; that hash result, in turn, falls into one of the bins associated with the entries in the block 704, thereby selecting the entry associated with that bin. The chosen entry (e.g., entry_{y2}) in the third table T₃ points to an entry (entry,) in the fourth table T₄.

At this stage, PM selection module 414 may uses information imparted by the entry, in the fourth table to generate an address associated with a particular PM module. The sending module 420 then encapsulates the packet into a new packet, e.g., corresponding to the encapsulated mirrored packet 422. The sending module 420 then sends the encapsulated mirrored packet 422 to the selected PM.

In one implementation, the table T₁ may correspond to an L3 table, the table T₂ may correspond to a group table, the table T₃ may correspond to an ECMP table, and the table T₄ may correspond to a tunneling table. These are tables that a commodity hardware switch may natively provide, although they are not linked together in the manner specified in FIG. 7. Nor are they populated with the kind of mapping information specified above. More specifically, in some implementations, these tables include slots having entries that are used in performing native packet-forwarding functions within a network, as well as free (unused) slots. The tracking system 102 can link the tables in the specific manner set forth above, and can then load entries into unused slots to collectively provide an instance of mapping information for multiplexing purposes.

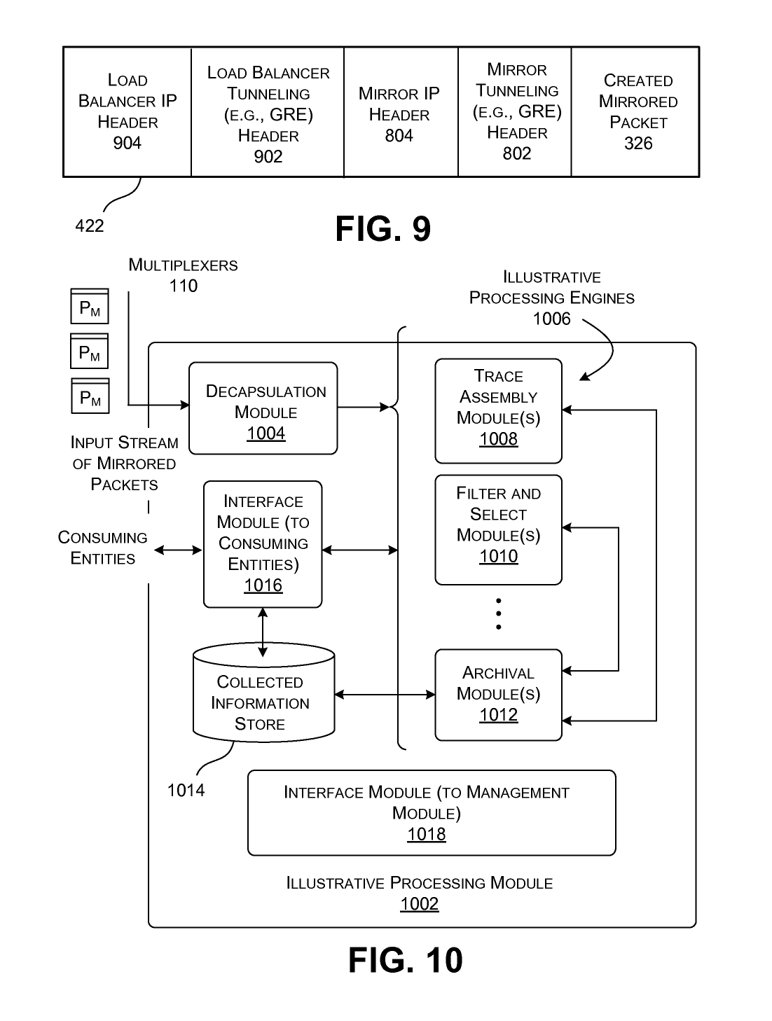

FIG. 9 shows an illustrative structure of the encapsulated mirrored packet 422 that is generated at the output of the multiplexer 402. The encapsulated mirrored packet 422 includes, as a first part thereof, the encapsulated mirrored packet 336 that is produced at the output of the switch 302. More specifically, the encapsulated mirrored packet 422 includes the mirrored packet 326, a mirror tunneling header 802, and a mirror IP header 804. In addition, the encapsulated mirrored packet 422 includes a new encapsulating load balancer tunneling header 902, such as a GRE tunneling header. A next encapsulating outer field includes a load balancer IP header 904. Other implementations may adopt other ways of encapsulating mirrored packet information at the output of the multiplexer 402.

As a final comment, the multiplexers 110 have a high throughput, particularly in the case in which the multiplexers 110 correspond to repurposed hardware switches or other hardware devices. This characteristic is one feature that allows the tracking system 104 to handle high traffic volumes; this characteristic also promotes the scalability of the tracking system 104.

A.5. Illustrative Processing Module

FIG. 10 shows one implementation of a processing module 1002, which is another component of the tracking system 102 of FIG. 1. The processing module 1002 receives a stream of mirrored packets from the multiplexers 110. As described above, the multiplexers 110 forward mirrored packets that pertain to the same path through the network 104 to the same processing module. Hence, in one implementation, the stream of mirrored packet that is received by the processing module 1002 will not contain mirrored packets that pertain to the flows handled by other processing modules.

A decapsulation module 1004 removes the outer headers from the received mirrored packets. For example, with respect to the encapsulated mirrored packet 422 of FIG. 9, the decapsulation module 1004 removes the headers (802, 804, 902, 904), to leave the original mirror packet 326 produced by the mirroring module 324 (of FIG. 3). However, so as to simplify the following explanation, the mirrored information that is processed by the processing module 1002 is henceforth referred to as simply mirrored packets. In other implementations, the processing module 1002 can retain at least some information that is provided in the outer headers, insofar as this information provides useful diagnostic information.

The processing module 1002 may include a collection of one or more processing engines 1006 that operate on the stream of mirrored packets. For example, at least one trace assembly module 1008 may group the set of mirrored packets together that pertain to the same flow or path through the network 104. In the example of FIG. 1, for instance, the trace assembly module 1008 can assembly the mirrored packets produced by switches 106, 126, and 128 into a single group, to yield the mirrored packet sequence 138. The trace assembly module 1008 can also order the mirrored packets in a group according to the order in which they were created. The trace assembly module 1008 can perform its function by consulting time stamp, sequence number, and/or other information captured by the mirrored packets.

At least one filter and select (FS) module 1010 can pick out one or more types of packets from the stream of mirrored packets that are received. For example, the FS module 1010 can pick out packets that pertain to a particular TCP flag, or a particular error condition, or a particular application, and so on. The FS module 1010 can perform its function by matching information provided in the received mirrored packets against a matching rule, e.g., by using regex functionality or the like.

An archival module 1012 stores the raw mirrored packets that are received and/or any higher-level information generated by the other processing engines 1006. The archival module 1012 may store any such information in a data store 1014, which may correspond to one or more physical storage mechanisms, provided at a single site or distributed over plural sites. For example, in one case, the archival module 1004 can store all of the raw mirrored packets received by the processing module 1002. In addition, or alternatively, the archival module 1012 can store the traces produced by the trace assembly module 1008. In addition, or alternatively, the archival module 1012 can store a selected subset of mirrored packets identified by the FS module 1010, and so on.

More specifically, the archival module 1012 can store the mirrored packets in different ways for different types of mirrored packets, depending on the projected needs of the consuming entities that will be consuming the mirrored packets. In some cases, the archival module 1012 can record complete traces of the mirrored packets. In other cases, the archival module 1012 can store certain mirrored packets produced in the paths, without necessarily storing the complete traces for these paths. For example, if explicit information is captured that indicates that a packet drop occurred at a particular switch, then the archival module 1012 may refrain from capturing the entire hop sequence up to the point of the packet drop.

An interface module 1016 allows any consuming entity, such as the consuming entity 114 of FIG. 1, to retrieve any information collected and processed by the processing module 1002. In one case, the consuming entity 114 may correspond to a human analyst who is using a computing device of any nature to receive and analyze the collected information. Alternatively, or in addition, the consuming entity 114 may correspond to an automated analysis program.

In one case, the consuming entity 114 may receive information that has been archived in the data store 1014. Alternatively, or in addition, the consuming entity 114 may receive mirrored packets as they are received by the processing module 1002, e.g., as a real time stream of such information. In one case, the interface module 1016 allows any consuming entity to interact with its resources via one or more application programming interfaces (APIs). For example, the interface module 1016 may provide different APIs for different modes of information extraction. The APIs may also allow the consuming entity to specify filtering criteria for use in extracted desired mirrored packets, etc.

The interface module 1016 may also receive instructions from the consuming entities. For example, an automated analysis program (e.g., as implemented by a consuming entity) can instruct the archival module 1012 to automatically and dynamically change the type and nature of the information that it logs, based on the informational needs of the analysis program.

Another interface module 1018 provides a mechanism for performing communication between the processing module 1002 and the management module 116 (of FIG. 1). For example, based on its analysis, the processing module 1002 may automatically send instructions to the management module 116, instructing the management module 116, in turn, to send updated packet-detection rules to the switches in the network 104. The new packet-detection rules will change the flow of mirrored packets to the processing module 1002. For example, the processing module 1002 can ask the management module 116 to provide a new set of rules to increase or decrease the volume of mirrored packets that it receives, e.g., by making the selection criteria less or more restrictive. In addition, or alternatively, the processing module 1002 may dynamically react to the type of information that is receiving. That is, for any application-specific reasons, it can affect a change in the packet-detection rules to capture additional types of packets of a certain type, or fewer packets of a certain type. For example, the processing module 1002 can collect a certain amount of evidence to suggest that a flooding attack is currently occurring; thereafter, it may request the management module 116 to throttle back on the volume of mirrored packets that it is received that further confirm the existence of a flooding attack.

The management module 116 can likewise use the interface module 1018 to send instructions to the processing module 1002, for any application-specific reason. For example, the management module 116 can proactively ask the processing module 1002 for performance data. The management module 116 may use the performance data to alter the behavior of the mirroring functionality in any of the ways described above. Still other environment-specific interactions between the management module 116 and the processing module 1002 may be performed.

A.6. Illustrative Consuming Entity

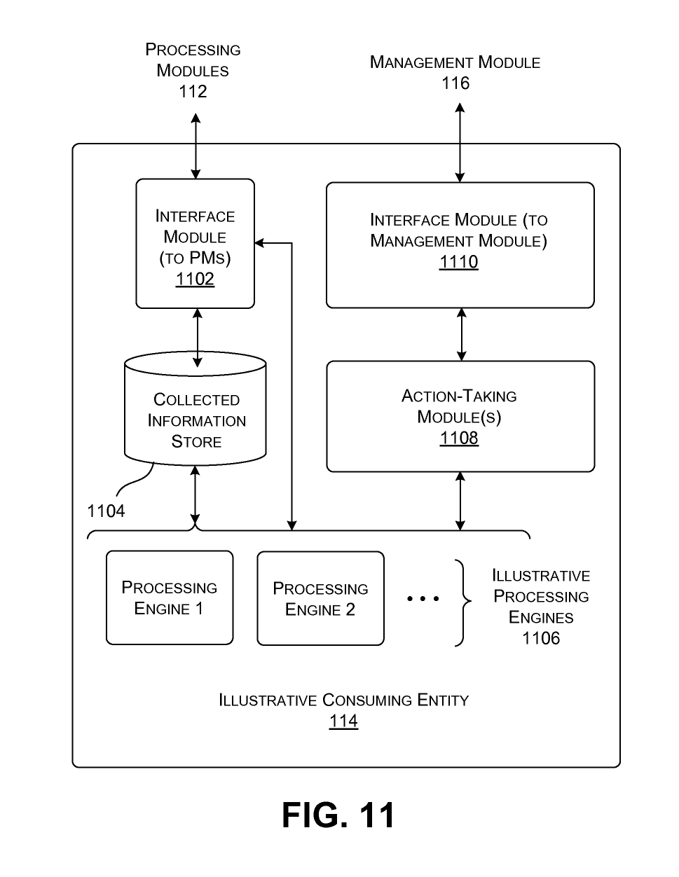

FIG. 11 shows one implementation of the consuming entity 114, introduced in the context of FIG. 1. As noted above, the consuming entity 114 may correspond to a computing device through which a human analyst performs analysis on the mirrored packets. Alternatively, or in addition, the consuming entity may correspond to one or more analysis programs that run one any type of computing device.

The consuming entity 114 includes an interface module 1102 for interacting with the processing modules 112, e.g., through one or more APIs provided by the processing modules 112. The consuming entity 114 may obtain any information captured and processed by the processing modules 112. In one case, the consuming entity 114 can make an information request to the entire collection of processing modules 112; the particular processing module (or modules) that holds the desired information will then respond by provided the desired information. Alternatively, or in addition, the processing modules 112 can automatically provide mirrored packet information to the consuming entity 114. For example, the consuming entity 114 can register one or more event handlers for the purpose of receiving desired packet-related information. The processing modules 112 can respond to these event handlers by providing the desired information when it is encountered. The consuming entity 114 can store the information that it collects in a data store 1104. As noted above, the consuming entity 114 may also send instructions and other feedback to the processing modules 112.

The consuming entity 114 can provide one or more application-specific processing engines 1106 for analyzing the received mirrored packet information. In one case, for example, a processing engine can examine TCP header information in the headers of collected mirror packets. That information reveals the number of connections established between communicating entities. The processing engine can compare the number of connections to a threshold to determine whether a flooding attack or other anomalous condition has occurred.

Another processing engine can examine the network 104 for broken links or misbehaving components that may be contributing to lost or corrupted information flow. Such a processing engine can determine the existence of a failure based on various evidence, such as by identifying prematurely truncated sequences of packets (e.g., where the packet did not reach its intended destination), and/or based on sequence of packets that contain missing hops, anomalous routes, etc. In addition, or alternatively, the processing engine can examine any of the following evidence: BGP or other routing information, error condition metadata added by the switches, ping-related packet information, etc. That is, the BGP information may directly reveal routing problems in the network, such as the failure or misbehavior of a link, etc. The error condition information may reveal that a particular switched has dropped a packet due to its corruption, or other factors. The ping-related packet information may reveal connectivity problems between two entities in the network. As described above, a ping application corresponds to an application that tests the quality of a connection to a remote entity by sending a test message to the remote entity, and listening for the response by the remote entity to the ping message.

Still other types of processing engines 1106 can be used by the consuming entity 114; the above examples were described in the spirit of illustration, not limitation.

The processing engines can be implemented in any manner, such as by rule-based engines, artificial intelligence engines, machine-trained models, and so on. For example, one rule-based processing engine can adopt a mapping table or branching algorithm that reflects a set of diagnostic rules. Each rule may be structured in an IF-THEN format. That is, a rule may specify that if an evidence set {X₁, X₂, . . . Xₙ} is present in the captured mirrored packets, then the network is likely to be suffering from an anomaly Y. The specific nature of these rules will be environment-specific in nature, depending on the nature of the network 104 that is being monitored, the objectives of analysis, and/or any other factor(s).

In some cases, a processing engine can also dynamically perform a series of tests, where a subsequent test may be triggered by the results of a former test (or tests), and may rely on conclusions generated in the former test(s).

At least one action-taking module 1108 can take action based on the results of the analysis provided by any of the processing engines 1106. For example, one action-taking module can notify a human analyst of the results of the analysis in any form, e.g., by providing an alert signal, a textual explanation of the cause of a detected failure, and so on. In another case, an action-taking module can proactively disable or otherwise modify the performance of a part of the network 104 that has been determined to be misbehaving. For example, that kind of action-taking module can disable communication routes to certain servers or other resources that are being attacked, block traffic that is originating from suspected malicious entities, and so on.

An interface module 1110 allows the consuming entity 114 to interact with the management module 116. For instance, the consuming entity 114 can send requests to the management module 116 for at least the same reasons that the processing modules 112 may do so. For example, a processing engine may wish to change the types of packets that is receiving, or change the volume of packets that it is receiving. To this end, the processing engine can make a request to the management module 116, instructing it to send updated packet-detection rules to the switches in the network 104. The updated rules, when placed in effect by the switches, will achieve the objectives of the processing engine.

As a final note with respect to FIGS. 1 and 11, these figures illustrate the processing modules 112 as agents which are separate from from the consuming entities. In other implementations, one or more functions that were described above as being performed by the processing modules 112 can, instead, be performed by a consuming entity. Indeed, in some implementations, the processing modules 112 can be entirely eliminated, and the consuming entities can receive the mirrored packets directly from the multiplexers 110.

A.7. Illustrative Management Module

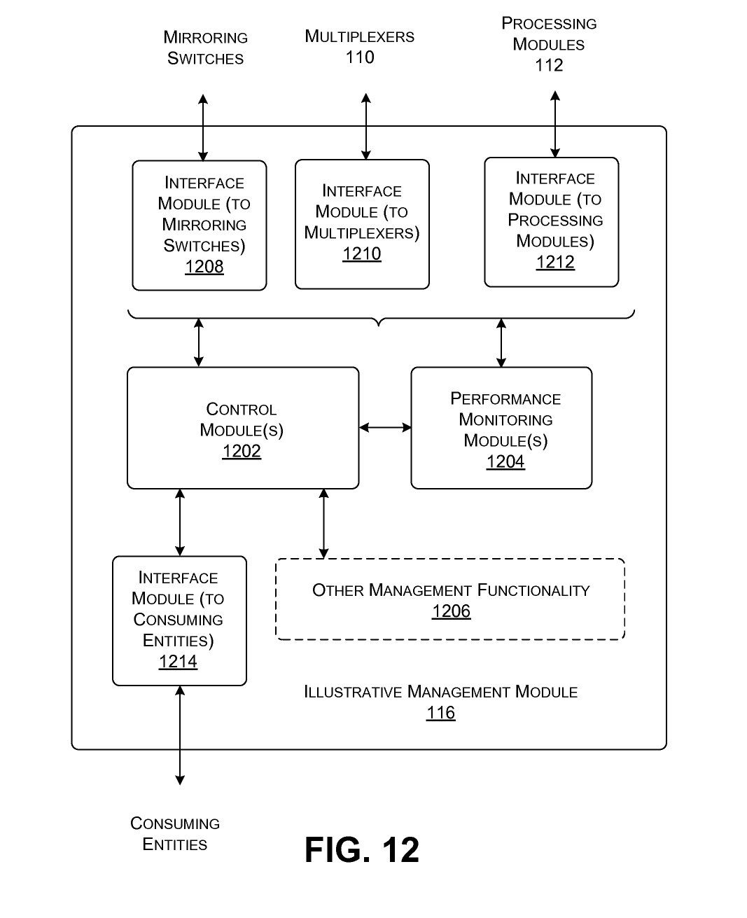

Finally, FIG. 12 shows one implementation of the management module 116. The management module 116 may use at least one control module 1202 to control various operations in the network switches, the multiplexers 110, the processing modules 112, etc. For example, the control module 1202 may provide sets of packet-detection rules to the switches, which govern the subsequent mirroring behavior of the switches. The control module 1202 can generate new rules based on one or more factors, such as explicit instructions from an administrator, explicit requests by a human analyst associated with a consuming entity, automated requests by any processing module or consuming entity, and so on.

In one case, the management module 116 instructs all the switches to load the same set of packet-detection rules. In other cases, the management module 116 can instruct different subsets of switches to load different respective sets of packet-detection rules. The management module 116 can adopt the later approach for any environment-specific reason, e.g., so as to throttle back on the volume of mirrored packets produced by a switch having high traffic, etc.

The management module 116 can also include at least one performance monitoring module 1204. That component receives feedback information regarding the behavior of the network 104 and the various components of the tracking system 102. Based on this information, the performance monitoring module 1204 may generate one or more performance-related measures, reflecting the level of performance of the network 104 and the tracking system 102. For example, the performance monitoring module 1204 can determine the volume of mirrored packets that are being created by the tracking system 102. A mirrored packet can be distinguished from an original packet in various ways. For example, each mirroring mechanism provided on a switch can add a type of service (TOS) flag to the mirrored packets that it creates, which may identify the packet as a mirrored packet.

The control module 1202 can also update the rules that it propagates to the switches on the basis of performance data provided by the performance monitoring module 1204. For example, the control module 1202 can throttle back on the quantity of mirrored packets to reduce congestion in the network 104 during periods of peak traffic load, so that the mirroring behavior of the tracking system 102 will not adversely affect the flow of original packets.

The management module 116 can also include any other functionality 1206 that performs other management operations. For example, although not explicitly stated in FIG. 12, the functionality 1206 can compile and send routing information to the switches. That routing information determines the manner in which the switches route original and mirrored packets through the network 104.

Finally, the management module 116 may include a number of interfaces for interacting with the various actors of the tracking system 102, including an interface module 1208 for interacting with the switches in the network 104, an interface module 1210 for interacting with the multiplexers 110, an interface module 1212 for interacting with the processing modules 112, and an interface module 1214 for interacting with the consuming entities.

B. Illustrative Processes

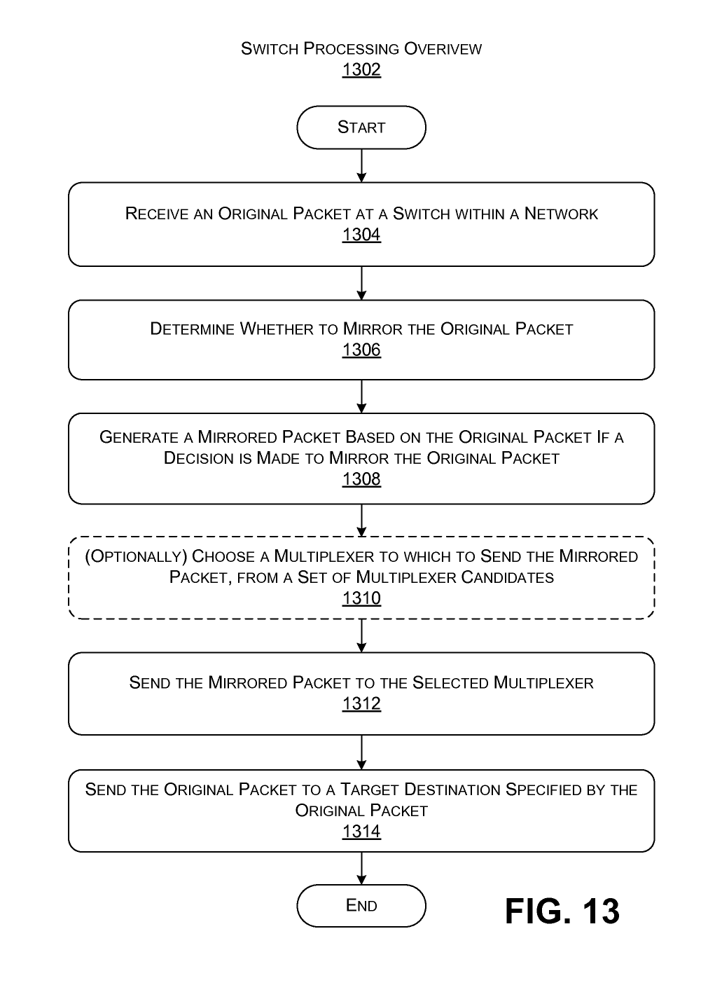

FIGS. 13-18 show processes that explain the operation of the tracking system 102 of Section A in flowchart form. Since the principles underlying the operation of the tracking system 102 have already been described in Section A, certain operations will be addressed in summary fashion in this section.

Starting with FIG. 13, this figure shows a process 1302 that explains one manner of operation of the switch 302 of FIG. 3. In block 1302, the switch 302 receives an original packet that is transmitted over the network 104. In block 1306, the switch 302 determines whether to mirror the original packet. In block 1308, the switch generates a mirrored packet based on the original packet, assuming that a decision is made to mirror the original packet. The mirrored packet includes at least a subset of information provided in the original packet. In block 1310, the switch 302 optionally chooses a multiplexer from a set of candidate multiplexers 110 based on at least one load balancing consideration. This operation is optional in the sense that, in some implementations, the tracking system 102 may provide only a single multiplexer, and therefore, no multiplexing among multiplexers would be necessary in that case. In block 1312, the switch 302 sends the mirrored packet to the chosen (or default) load balancing multiplexer. In block 1314, the switch 302 sends the original packet to target destination specified by the original packet. The above operations are described in series to simplify explanation; but any of these operations can also be performed in parallel, such as operations 1312 and 1314.

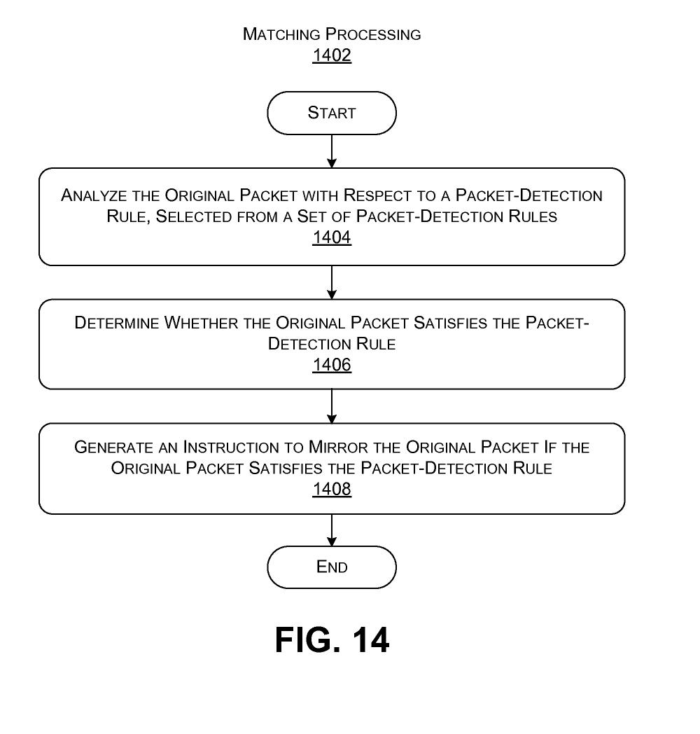

FIG. 14 shows a process 1402 that explains one manner of operation of the matching module 320, which is a component of the switch 302 of FIG. 3. In block 1404, the matching module 320 analyzes the original packet with respect to at least one packet-detection rule. In block 1406, the matching module 320 determines whether the original packet satisfies the packet-detection rule. In block 1408, the matching module 320 generates an instruction to mirror the original packet if the original packet satisfies the packet-detection rule. In actual practice, the matching module 320 can perform the operations of FIG. 14 with respect to a set of packet-detection rules, in series or in parallel.

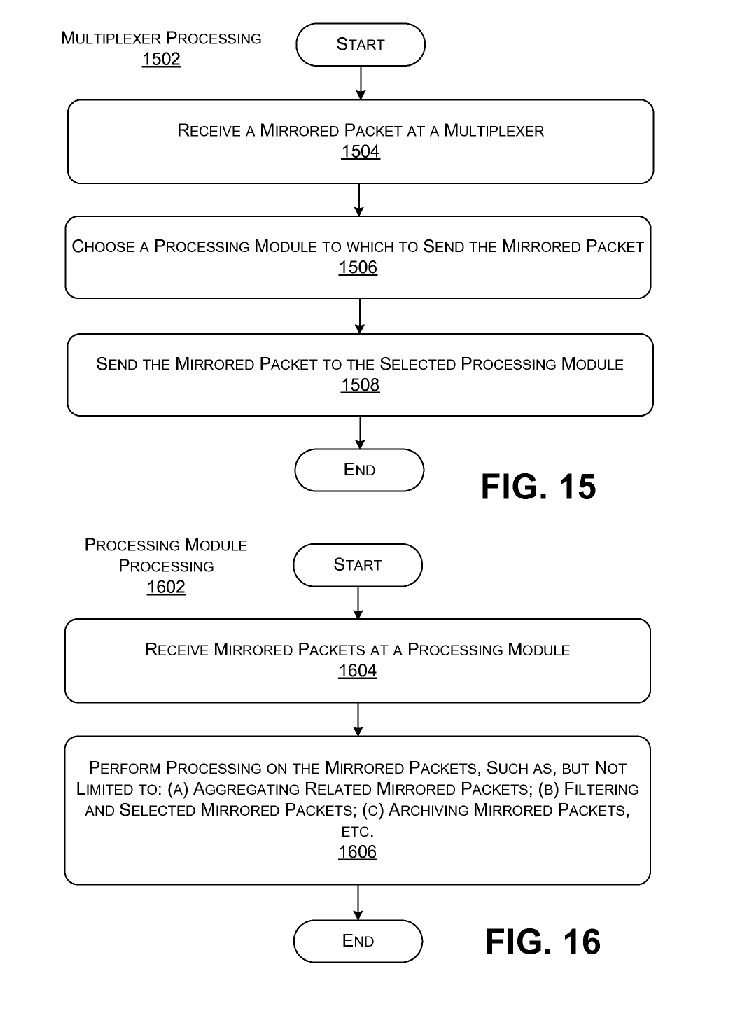

FIG. 15 shows a process 1502 that explains one manner of operation of the multiplexer 402 of FIG. 4. In block 1504, the multiplexer 402 receives a mirrored packet. In block 1506, the multiplexer 402 chooses a processing module from a set of processing module candidates, based on at least one load balancing selection consideration. For example, the multiplexer 402 may use the above-described hashing technique to select among processing module candidates, while also ensuring that packets that belong to the same flow are sent to the same processing module. In block 1508, the multiplexer 402 sends the mirrored packet to the processing module that has been chosen.

FIG. 16 shows a process 1602 that explains one manner of operation of the processing module 1002 of FIG. 10. In block 1604, the processing module 1002 receives mirrored packets from the multiplexers 110. In block 1606, the processing module 1002 performs any type of processing on the mirrored packets, such as, but not limited to: assembling sequences of related mirrored packets (e.g., which pertain to the same flows); filtering and selecting certain mirrored packets; archiving mirrored packets and/or the results of the analysis performed by the processing module 1002, and so on.

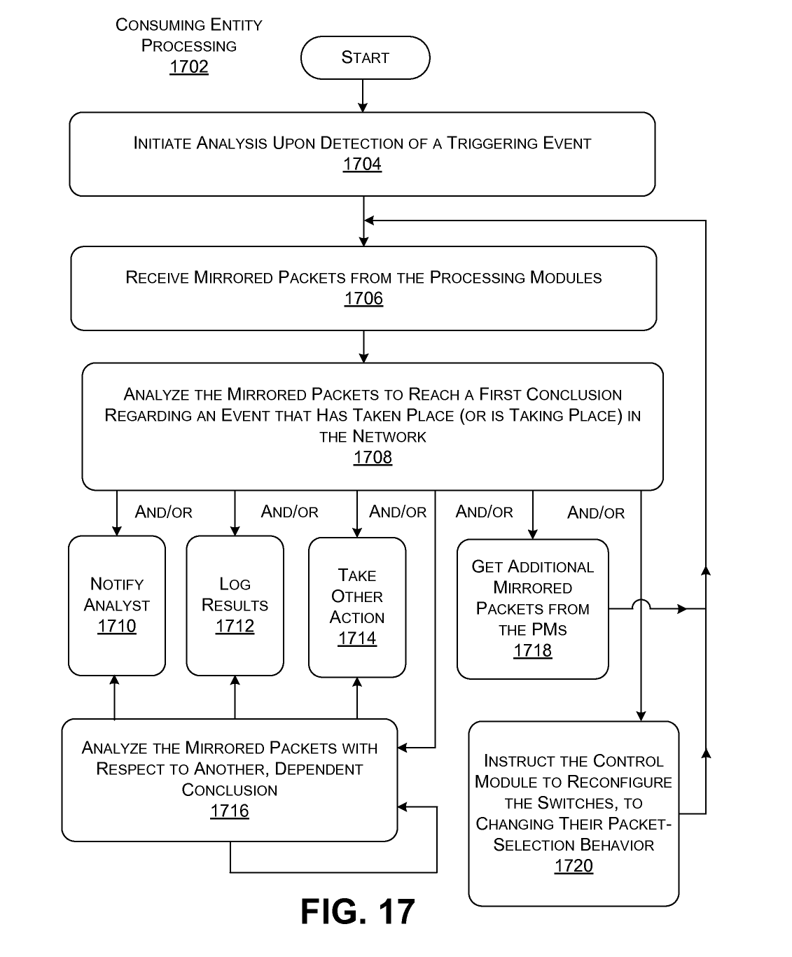

FIG. 17 shows a process 1702 that explains one non-limiting and representative manner of operation of the consuming entity 114 of FIG. 11. In block 1704, the consuming entity 114 determines whether to begin its analysis of mirrored packets. For example, assume that the consuming entity 114 is associated with a particular application that interacts with the network 104 or places some role in the network 104, such as a TCP-related application or a BGP-related application. In one mode of operation, such an application can, independently of the tracking system 102, determine that a failure or other undesirable event has occurred in the network 104. In response, the application can request the switches to begin collecting certain types of mirrored packets. That is, the application can make such a request to the management module 116, which, in turn, sends one or more packet-detection rules to the switches which, when applied by the switches, will have the end effect of capturing the desired packets. In another mode of operation, an application may request the switches to collect certain packets in the normal course of operation, without first encountering an anomalous condition. Still other modes of operation are possible.

In block 1706, the consuming entity 114 receives mirrored packets and/or analysis results provided by the processing modules 112. The consuming entity 114 may use a push technique, a pull technique, or a combination thereof to obtain the information in block 1706. In block 1708, the consuming entity 114 analyzes the mirrored packets to reach a first conclusion regarding an event that has taken place in the network 104, or that is currently taking place in the network 104. Thereafter, based on this first conclusion, the consuming entity 114 can take one or more actions, examples of which are summarized in FIG. 17.

For example, in block 1710, the consuming entity 114 can notify a human analyst, an administrator, or any other entity of anomalous conditions within the network 104. The consuming entity 114 may use any user interface presentations to convey these results. Alternatively, or in addition, in block 1712, the consuming entity 114 can log the results of its analysis. Alternatively, or in addition, in block 1714, the consuming entity 114 can take any other action, such as by disabling or otherwise changing the behavior of any part of the network 104.

In addition, or alternatively, in block 1716, the consuming entity 114 can use the first conclusion to trigger another round of analysis. That second round of analysis may use the first conclusion as input data. Such an iterative investigation can be repeated any number of times until the human analyst or an automated program reaches desired final conclusions. Note that the analysis of block 1716 takes place with respect to mirrored packet information that the consuming entity 114 has already received from the processing modules 112.

In addition, or alternatively, in block 1718, the consuming entity 114 can interact with the processing modules 112 to obtain additional packet-related information from the processing modules 112. In addition, or alternatively, the consuming entity 114 can interact with the management module 116 to request that it change the packet-detection rules that are loaded on the switches. This change, in turn, will change the type and/or volume of packets that the consuming entity 114 receives from the processing modules 112. The consuming entity 114 can then repeat any of the operations described above when the additional packet-related information has been received.

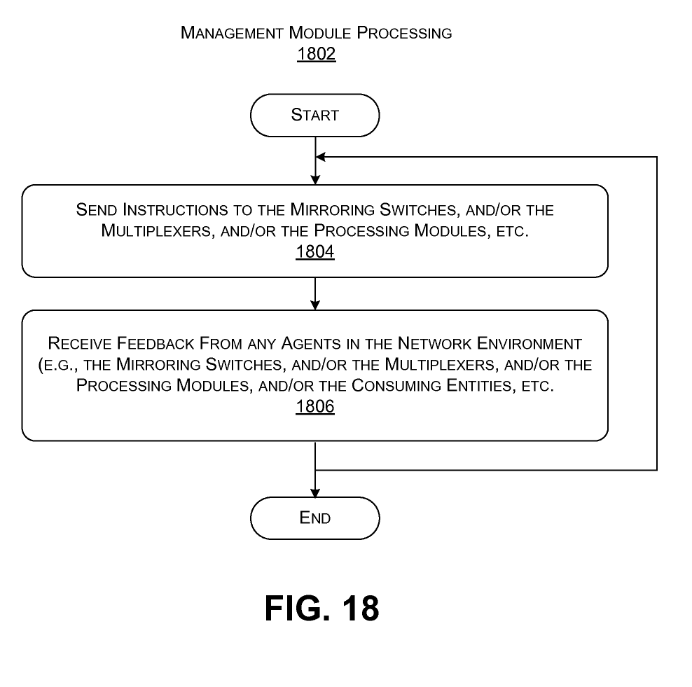

Finally, FIG. 18 shows a process 1802 that explains one manner of operation of the management module 116 of FIG. 12. In block 1804, the management module 116 can send various instructions to the components of the tracking system 102, such as the switches in the network 104, the multiplexers 110, the processing modules 112, and so on. For example, the management module 116 can send an updated set of packet-detection rules to the switches, which will thereafter govern their packet mirroring behavior in a particular manner. In block 1806, the management module 116 receives feedback from various entities, such as the switches, the multiplexers 110, the processing modules 112, the consuming entities, and so on. In the manner described above, the management module 116 may subsequently use the feedback to update its instructions that it sends to various agents, that is, in a subsequent execution of the block 1804. The management module 116 may also perform other management functions that are not represented in FIG. 18.

C. Representative Computing Functionality

FIG. 19 shows computing functionality 1902 that can be used to implement any aspect of the tracking functionality set forth in the above-described figures. For instance, the type of computing functionality 1902 shown in FIG. 19 can be used to implement any of: a software-implemented multiplexer (if used in the tracking system 102 of FIG. 1), any packet processing module, the management module 116, any consuming entity (such as the consuming entity 114), and so on. In all cases, the computing functionality 1902 represents one or more physical and tangible processing mechanisms.

The computing functionality 1902 can include one or more processing devices 1904, such as one or more central processing units (CPUs), and/or one or more graphical processing units (GPUs), and so on.

The computing functionality 1902 can also include any storage resources 1906 for storing any kind of information, such as code, settings, data, etc. Without limitation, for instance, the storage resources 1906 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 1902. The computing functionality 1902 may perform any of the functions described above when the processing devices 1904 carry out instructions stored in any storage resource or combination of storage resources.

As to terminology, any of the storage resources 1906, or any combination of the storage resources 1906, may be regarded as a computer readable medium. In many cases, a computer readable medium represents some form of physical and tangible entity. The term computer readable medium also encompasses propagated signals, e.g., transmitted or received via physical conduit and/or air or other wireless medium, etc. However, the specific terms “computer readable storage medium” and “computer readable medium device” expressly exclude propagated signals per se, while including all other forms of computer readable media.

The computing functionality 1902 also includes one or more drive mechanisms 1908 for interacting with any storage resource, such as a hard disk drive mechanism, an optical disk drive mechanism, and so on.

The computing functionality 1902 also includes an input/output module 1910 for receiving various inputs (via input devices 1912), and for providing various outputs (via output devices 1914). Illustrative input devices include a keyboard device, a mouse input device, a touchscreen input device, a digitizing pad, one or more video cameras, one or more depth cameras, a free space gesture recognition mechanism, one or more microphones, a voice recognition mechanism, any movement detection mechanisms (e.g., accelerometers, gyroscopes, etc.), and so on. One particular output mechanism may include a presentation device 1916 and an associated graphical user interface (GUI) 1918. Other output devices include a printer, a model-generating mechanism, a tactile output mechanism, an archival mechanism (for storing output information), and so on. The computing functionality 1902 can also include one or more network interfaces 1920 for exchanging data with other devices via one or more communication conduits 1922. One or more communication buses 1924 communicatively couple the above-described components together.

The communication conduit(s) 1922 can be implemented in any manner, e.g., by a local area network, a wide area network (e.g., the Internet), point-to-point connections, etc., or any combination thereof. The communication conduit(s) 1922 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 1902 can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc.

In closing, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

What is claimed is:

1. A method for collecting packets from a network, comprising:
receiving an original packet at a switch within a network;
determining whether to mirror the original packet;
generating a mirrored packet based on the original packet, providing that a decision is made to mirror the original packet, the mirrored packet including at least a subset of information provided in the original packet;
sending the mirrored packet to a load balancing multiplexer; and
sending the original packet to a target destination specified by the original packet.

2. The method of claim 1, wherein said determining of whether to mirror the original packet comprises:
analyzing the original packet with respect to a packet-detection rule;
determining whether the original packet satisfies the packet-detection rule; and
generating an instruction to mirror the original packet if the original packet satisfies the packet-detection rule.

3. The method of claim 2, wherein the packet-detection rule specifies that each original packet that expresses a specified protocol-related characteristic is to be mirrored.

4. The method of claim 3, wherein the protocol-related characteristic is expressed by at least one information item produced by a transport layer protocol.

5. The method of claim 3, wherein the protocol-related characteristic is expressed by at least one information item produced by a routing protocol.

6. The method of claim 2, wherein the packet-detection rule specifies that each original packet that originated from a specified application is to be mirrored.

7. The method of claim 2, wherein the packet-detection rule corresponds to a user-created packet-detection rule, and wherein the user-created packet detection rule specifies that each original packet that satisfies a user-specified matching condition is to be mirrored.

8. The method of claim 2, wherein the packet-detection rule specifies that each original packet that expresses that the switch encountered a specified condition, upon processing the packet, is to be mirrored.

9. The method of claim 8, wherein the specified condition indicates that the original packet is to be dropped by the switch.

10. The method of claim 2, wherein the packet-detection rule specifies that each original packet that specifies an identified service type is to be mirrored.

11. The method of claim 2, wherein the packet-detection rule specifies that each original packet that is produced by a ping-related application is to be mirrored, the ping-related application operating by sending the original packet to a target entity, upon which the target entity is requested to send a response to the original packet.

12. The method of claim 1, further comprising choosing the multiplexer from a set of multiplexer candidates, based on at least one load balancing consideration.

13. The method of claim 1, wherein the switch is a hardware-implemented switch.

14. The method of claim 1, wherein the multiplexer is a hardware-implemented multiplexer.

15. The method of claim 14, wherein the hardware-implemented multiplexer is a hardware-implemented switch that is configured to function as a multiplexer.

16. The method of claim 1, further comprising:
receiving the mirrored packet at the multiplexer;
choosing a processing module from a set of processing module candidates, based on at least one load balancing consideration; and
sending the mirrored packet to the processing module that is chosen.

17. One or more computing devices for analyzing packets collected from a network, comprising:
an interface module for receiving a plurality of mirrored packets from at least one processing module,
each mirrored-packet being produced by a switch in the network and forwarded to said at least one processing module in response to processing an original packet, providing that the original packet satisfies at least one packet-detection rule, among a set of packet-detection rules, and
each mirrored packet including at least a subset of information provided in the original packet;
at least one processing engine that is configured to process the mirrored packets to reach at least one conclusion regarding an event that has occurred or is occurring in the network; and
an action-taking module configured to take an action based on said at least one conclusion.

18. The one or more computing devices of claim 17, wherein the action-taking module is configured to send an instruction that will cause at least some switches in the network to modify their respective sets of detection rules.

19. A switch, corresponding to a physical device, for use in a network, comprising:
a receiving module configured to receive an original packet;
a matching module configured to determine whether to mirror the original packet by determining whether the original packet satisfies at least one packet-detection rule among a set of packet-detection rules;
a mirroring module configured to generate a mirrored packet based on the original packet, providing that a decision is made to mirror the original packet, the mirrored packet including at least a subset of information provided in the original packet;
a mirror-packet sending module configured to send the mirrored packet to a load balancing multiplexer; and
an original-packet sending module configured to send the original packet to a target destination specified by the original packet.

20. The switch of claim 19, further comprising a target multiplexer selection module configured choose the multiplexer from a set of multiplexer candidates, based on at least one load balancing consideration.
